(19) United States
(12) Patent Application Publication
(10) Pub. No.: US 2020/0018228 A1
(43) Pub. Date: Jan. 16, 2020

(54) ROTARY COMBUSTION ENGINE ROTOR DEACTIVATION AND METHOD

(71) Applicant: Avner RONEN, Haifa (IL)

(72) Inventor: Avner RONEN, Haifa (IL)

(21) Appl. No.: 16/036,480

(22) Filed: Jul. 16, 2018

(51) Int. Cl. F02B 53/02; F04C 11/00; F04C 14/06; F04C 15/00

(52) U.S. Cl. CPC F02B 53/02; F04C 11/003; F02B 2053/005; F04C 15/0073; F04C 14/065

(57) ABSTRACT

A method and a Rotary Combustion Engine (RCE) suitable for deactivation of at least one rotor out of a plurality of rotors. The RCE includes at least a first shaft portion and a second shaft portion which are disposed in straight coextensive longitudinal axial alignment. Each shaft portion may support at least one rotor. The at least first shaft portion and second shaft portion are separated by a gap. A shaft coupling mechanism is operable to bridge the gap and couple the first shaft portion in engagement with the second shaft portion for rotation together. The shaft coupling mechanism is also operable to disengage the first shaft portion and the second shaft portion, and thereby deactivate the rotation of at least one rotor.

### TECHNICAL FIELD

The embodiments described herein below relate to Rotary Combustion Engines (RCE) such as a Wankel engines, and in particular to the reversible deactivation of at least one rotor of such an engine.

### BACKGROUND ART

### Summary of Invention

It is an object of the embodiments of the present invention to provide a Rotary Combustion Engine (RCE) suitable for the deactivation of at least one rotor out of a plurality of rotors. The RCE may comprise at least a first shaft portion and a second shaft portion, thus at least two shaft portions which are disposed in straight coextensive longitudinal axial alignment. Each one shaft portion is configured to support at least one rotor. The first shaft portion and the second shaft portion are separated apart by a gap. A shaft coupling mechanism is operable to couple the first shaft portion in engagement with the second shaft portion for rotation together. Furthermore, the shaft coupling mechanism is operable to disengage the first shaft portion from the second shaft portion, and thereby, to deactivate the rotation of at least one rotor.

It is a further object of the embodiments of the present invention to provide a method for reversibly deactivating at least one rotor of a Rotary Combustion Engine (RCE) having a plurality of rotors. The method comprises an RCE which has at least a first shaft portion and a second shaft portion, thus at least two shaft portions. Those at least two shaft portions are disposed in straight mutual coextensive longitudinal axial alignment. Each one shaft portion operates at least one rotor. Moreover, the first shaft portion is separated apart from the second shaft portion by a gap. There is also provided a shaft coupling mechanism for coupling the first shaft portion and the second shaft portion into simultaneous synchronous rotation and indexed angle. The shaft coupling mechanism may also separate and disengage the first shaft portion from the second shaft portion to thereby deactivate the operation of at least one rotor out of the plurality of rotors.

### Technical Problem

The difficulties encountered in the attempts to deactivate reciprocating pistons of internal combustion engines (ICE) are well known from the days of the Cadillac V8-6-4 engine. With an RCE (Rotary Combustion Engine), one may consider the problem of deactivation one or more rotating rotor(s) to be similar to the problem of deactivation of reciprocating pistons. The problem is thus how to deactivate a rotating rotor of an RCE, or rotary combustion engine.

Solution of the Problem

Contrary to the crankshafts of reciprocating piston internal combustion engines (ICE) with cranks and throw pins, the shaft which supports the rotor(s) of an RCE, such as a Wankel engine for example, features a shaft which extends in straight coextensive longitudinal axial alignment. Therefore, to deactivate a rotor, it suffices to disengage from rotation that portion of the shaft which supports the rotor(s) to be deactivated.

The solution of the problem is achieved by dividing the shaft of an RCE into two shaft portions that are separated apart by a gap. Upon separation of the rotating shaft of a running RCE by the gap, the first shaft portion, or rotation output portion, will continue to rotate but the second shaft portion, now separated apart therefrom by the gap, will come to standstill, and so will the rotor(s) supported by the second shaft portion.

To reunite two shaft portions for rotating together in common rotation, use may be made of a shaft coupling mechanism SCM to form a united shaft which will activate the rotor(s) previously deactivated by the separation of the shaft into two shaft portions. One or more coupling element(s) of the coupling mechanism SCM will provide not only rotational speed synchronization but also phase synchronization for preservation of the required mutual angular relationship existing between rotors. Such requirement is necessary for smooth operation of the RCE and for mitigating vibrations.

A shaft coupling mechanism SCM, configured to reversibly operate the disengagement of a first shaft portion from a second shaft portion, will disengage the second shaft portion and the thereby deactivate the supported rotor(s). Operation of the shaft coupling mechanism SCM to couple back the first shaft portion together with the second shaft portion will return the deactivated rotor(s) of the RCE into operation.

### Advantageous Effects of Invention

In certain situations, such as low load, the deactivation of a rotor allows the RCE to operate at or closer to engine optimal operational conditions, with less pollution damage to the environment, and with reduced fuel consumption. For example, when the RCE runs at idle speed or at light or partial load, it may be more economical to deactivate one or a portion of the available rotors. Evidently, a deactivated rotor is not fed with fuel/gas and ignition to that rotor may be discontinued.

### BRIEF DESCRIPTION OF DRAWINGS

Exemplary embodiments are illustrated in referenced figures. It is intended that the embodiments and figures disclosed herein are to be considered illustrative, rather than restrictive. The embodiments of the invention, however, both as to organization and method of operation, together with objects, features, and advantages thereof, may best be understood by reference to the following detailed description when read in association with the accompanying figures, in which:

FIGS. 1 and 2 depict the background art,

FIG. 3 illustrates two disconnected shaft portions,

FIGS. 4 and 5 depict an exterior surface shaft coupling mechanism,

FIG. 6 is a cross section of a male and of a female splined shaft,

FIG. 7 depicts an interior shaft coupling mechanism,

FIG. 8 shows a frontal shaft coupling mechanism,

FIG. 9 is a block diagram of a flow control process,

FIG. 10 depicts three shaft portions,

FIG. 11 is a cross-section of an interior shaft coupling mechanism embodiment,

FIG. 12 shows a further interior shaft coupling mechanism embodiment, and

FIG. 13 illustrates an embodiment of a frontal shaft coupling mechanism,

### DESCRIPTION OF EMBODIMENTS

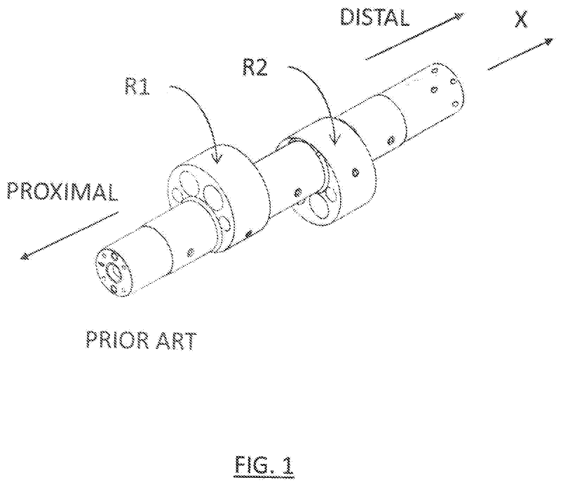

FIG. 1 shows a prior art SHFT pertaining to an RCE (Rotary Combustion Engine) 100 which extends in straight coextensive longitudinal extension along the X-axis. The shaft SHFT supports for example two rotors R1 and R2 which are disposed in angular indexed relation to each other. Bearings that support the shaft SHFT or shaft portions SH, hollowed or not, as well as balancing weights and lubrication means, well known in the art, are not described, and are not shown in the Figs. It is noted that Israel Patent Application No. 241420 of Sep. 9, 2015, to the same Applicants, divulges hollow shafts and lubrication of bearings.

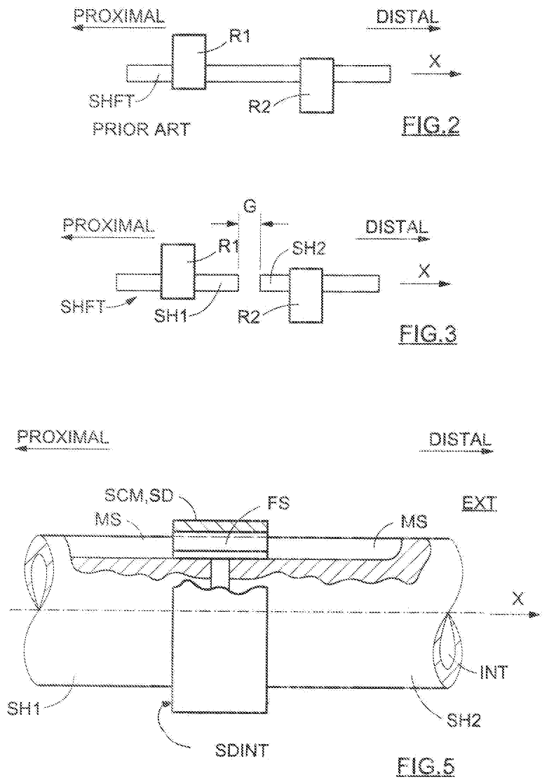

For the sake of clarity and simplicity of the drawings, the Figs. are rendered schematically, for example, in the manner in which FIG. 1 is rendered as FIG. 2.

FIG. 2 is a simplified schematic depiction of the prior art shaft SHFT and of the rotors R1 and R2 shown in FIG. 1, but the angular indexed relation between the rotors R1 and R2 is not seen in FIG. 2. In principle, to deactivate one rotor R out of the two rotors R1 and R2 supported by the shaft SHFT, it suffices to deactivate the rotation of that portion of the shaft which supports the rotor R to be deactivated.

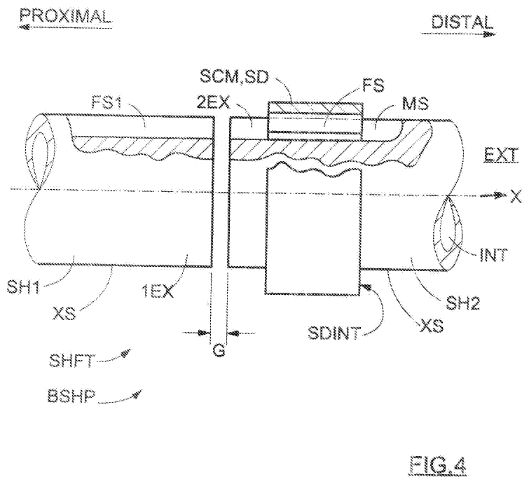

FIG. 3 schematically illustrates an exemplary embodiment showing a first shaft portion SH1 which supports a first rotor R1 and is separated apart by a gap G from a second shaft portion SH2 which supports a second rotor R2. The gap G suffices to disengage the second shaft portion SH2 from the first shaft portion SH1 so as to deactivate the second rotor R2. The width of the gap G, or interstice G, may be defined as the separation necessary to prevent the transmission of torque between, for example, the rotating first shaft portion SH1 and the disengaged second shaft portion SH2. Hence, a gap G of 0 mm, which does not transfer torque, and a gap in excess thereof are acceptable. The gap G shown in the Figs. is wide open for the sake of illustration, and is not to scale. Contrary to the Cadillac V8-6-4 engine, deactivation is not limited to suspension or interruption of the supply of fuel/gas and ignition to the engine, but deactivation here means in addition, disengagement of the shaft portion SH2 and deactivation of the rotor R2. The additional benefit is the absence of friction forces associated with the disengaged shaft portion SH2 and the deactivated rotor R2.

In the description hereinbelow, it may be assumed that when the second distal shaft portion SH2 is disengaged, it is the proximal first shaft portion SH1 that continues to provide rotative power output. Reference to two shaft portions SH1 and SH2 and to two rotors R1 and R2 is used for the sake of simplicity of description and of the drawings. Proximal and distal directions are indicated in the Figs. by arrows marked as, respectively, proximal and distal. A shaft SHFT as shown in FIGS. 1 and 2 may evidently be divided into more than two shaft portions SH1 and SH2, wherein each shaft portion SH may support a plurality of rotors R.

To rotate both the first and the second shaft portions, respectively SH1 and SH2, in synchronous rotation and in angular indexed relation, there is provided a shaft coupling mechanism SCM. In principle, a shaft coupling mechanism SCM for crossing or bridging the gap G may include a geared or splined bushing, having a slide dog interior SDINT and exterior EXT, configured to engage the first shaft portion SH1 together with the second shaft portion SH2 for rotation in common.

FIG. 4 shows a schematic exemplary embodiment of a shaft coupling mechanism SCM disposed on an exterior surface XS of the first shaft portion SH1 and of the second shaft portion SH2. The shaft portions may be partially hollow, completely hollow, or solid. The shaft coupling mechanism SCM may be engaged on a proximal shaft extremity 2EX of the second shaft portion SH2 which supports male splines MS. The male splines MS on the shaft extremity 2EX is disposed parallel to the longitudinal axis X of the shaft SHFT along which the first and the second shaft portions SH1 and SH2 are coextensively aligned in longitudinal axial extension and along which the shaft coupling mechanism SCM may move in controlled bidirectional longitudinal translation. The second proximal shaft extremity 2EX the second shaft portion SH2 is separated apart from the first distal shaft extremity 1EX of the first shaft portion SH1 by the gap G. The first shaft extremity 1EX also supports male splines MS which are similar to the splines on the second shaft extremity 2EX.

The shaft coupling mechanism SCM, which is configured as a slide dog SD in FIG. 4, supports female splines FS configured to engage the male splines MS on both shaft portions BSHP. The wording ‘both shaft portions BSHP’ is intended to mean ‘the first shaft portion SH1 and the second shaft portion SH2’.

A proximal translation of the slide dog SD across the gap G and onto the proximal first extremity 1EX of the first shaft portion SH1 allows the rotation in common of both engaged shaft portions BSHP.

FIG. 5 is the same exemplary embodiment as shown in FIG. 4 but showing the shaft coupling mechanism SCM when engaged with both shaft portions BSHP for rotation together.

A splined shaft with male splines MS is defined as a shaft having a number of equally spaced grooves cut on the exterior surface of the shaft so as to form a series of projecting keys and fitting into an internally grooved cylindrical member which is a female splined shaft having recessed splines FS. Splined shafts do transfer torque and maintain angular correspondence. A male master spline MMSTR wider than the other male splines MS and configured to engage a matching female master spline FMST may be provided to maintain a predetermined relative angular orientation between rotors R.

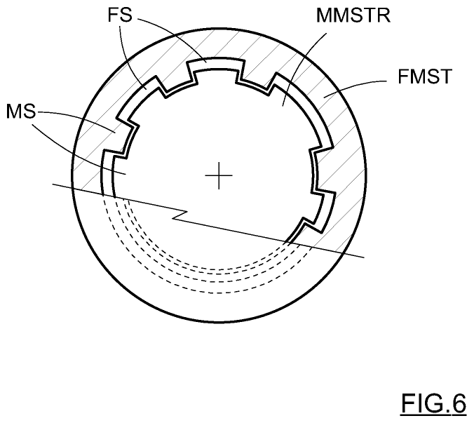

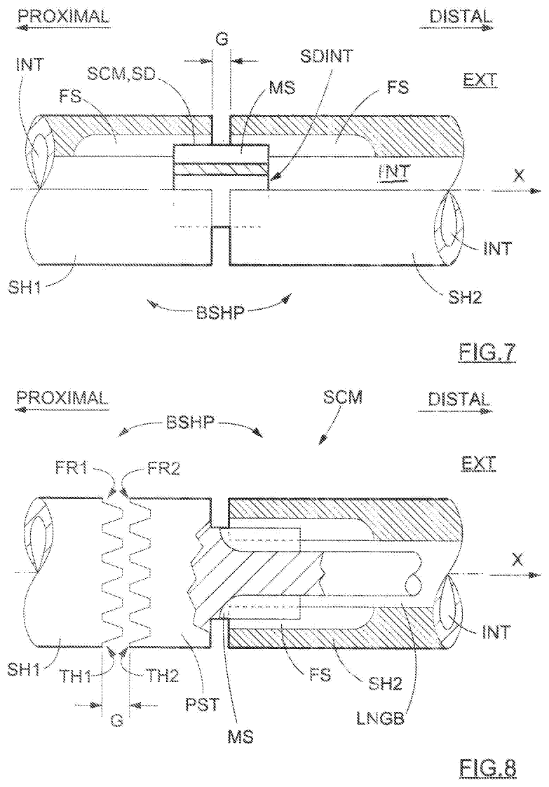

FIG. 6 depicts a partial cross-section of a shaft supporting male splines MS engaged in matching association with female splines FS of a hollow shaft. A female master spline FMST is shown in matching coupling with a male master spline MMSTR. The use of a master spline MMSTR as an indexing key, in association with a female master spline FMST, is suitable to couple the first shaft portion SH1 and the second shaft portion SH2 in both synchronous rotational speed engagement and in angular indexed engagement relationship.

FIG. 7 depicts a schematic exemplary embodiment showing that both shaft portions BSHP which are separated apart by a gap G, may have a hollowed out interior INT and support the same female splines FS. A shaft coupling mechanism SCM, with male splines MS matching the female splines FS, is disposed in the INT of and in engagement with both shaft portions BSHP, namely the first shaft portion SH1 and of the second shaft portion SH2. Translation of the shaft coupling mechanism SCM along the female splines FS, far enough in the interior INT either distally or proximally, will disengage the second shaft portion SH2 from the first shaft portion SH1. It is noted that the shaft coupling mechanism SCM may be implemented as a slide dog SD.

FIG. 8 depicts a schematic exemplary embodiment of a coupling mechanism SCM for the frontal coupling of both shaft portions BSHP which are separated apart by a gap G. The distal front face FR1 of the first shaft portion SH1 has a frontal set of teeth TH1 and the proximal front face of a piston PST slidable in a longitudinal bore LNGB of the second shaft portion SH2 has a set of frontal set of teeth TH2. Male splines MS supported by the piston PST engage female splines FS which are supported in a hollowed out portion INT of the second shaft portion SH2. To engage both shaft portions BSHP for rotation in common, the piston PST is driven proximally. Thereby, the male splines MS translate proximally along the female splines FS while simultaneously, the second set of teeth TH2 is driven proximally into the first set of teeth TH1. For disengagement, the piston PST is retracted distally to disengage the teeth TH2 of the piston PST from the teeth TH1 of the first shaft portion SH1.

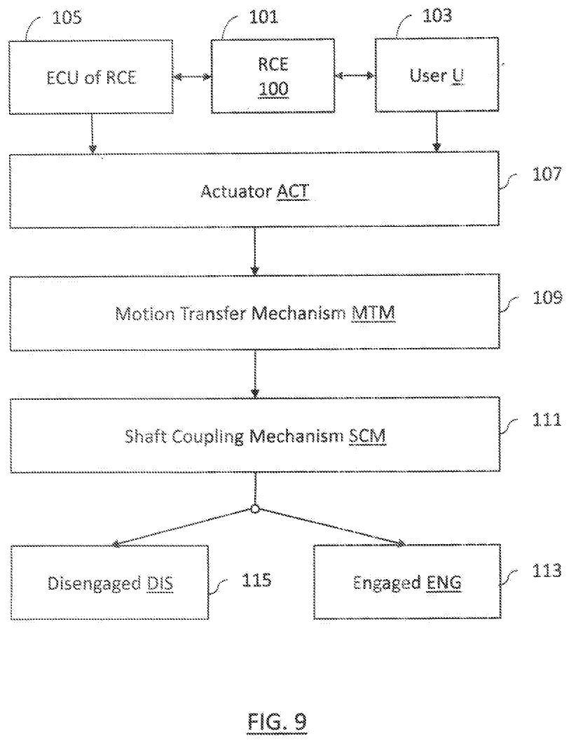

FIG. 9 is a block diagram showing an exemplary flow of control for either the disengagement or the engagement of, for example, a first shaft portion SH1 and a second shaft portion SH2 of an RCE 100 shown in block 101. The operation of the control process may be manual, as commanded for example by a user U shown in block 103, or may be automatic, as executed by an engine control unit ECU, shown in block 105, which engine control unit ECU monitors the functioning and performance of the RCE 100.

The deactivation of one or more rotors R may be advantageous to run the RCE 100 at optimal operational condition for example with a vehicle, not shown in the Figs., at standstill for a lengthy period of time while the RCE 100 is running just for the sole purpose to charge a battery. Evidently, the engine control unit ECU of the RCE 100 may automatically detect that say, the output provided by a single rotor R suffices to drive a generator for recharging a battery.

Upon command of the user U, or of the engine control unit ECU, an actuator ACT, shown in block 107, may impart a motion via one or more of a motion transfer mechanism MTM of block 109, to the shaft coupling mechanism SCM shown in block 111. Such a motion may include for example, a translation of a slide dog SD and/or of another element of the shaft coupling mechanism SCM. The actuator is thus coupled to controllably operate the shaft coupling mechanism SCM. The actuator ACT may be selected as an apparatus that is mechanic, pneumatic, hydraulic or electric, or as a combination of such apparatus, like for example, an electro-mechanical device. When it is the user U who is in command, he himself may exert, by hand or by foot, the force necessary to operate the shaft coupling mechanism SCM, whereby the actuator ACT becomes superfluous.

Alternatively, the user U may operate a device, not shown, to set the actuator ACT into operation. Once the actuator ACT performed the requested motion, it is the task of the motion transfer mechanism MTM, shown in block 109, to drive the shaft coupling mechanism SCM into desired position, either in a shaft portions SH(s) engaged position ENG, shown in block 113, by which a rotor(s) R enters the “ACTIVATED” state, or in a portions SH(s) disengaged position DIS, shown in block 115, by which a rotor R or rotors R(s) reaches the “DEACTIVATED” state.

For the sake of ease of description, the exemplary embodiments described hereinabove referred to an RCE 100 having two shaft portions SH1 and SH2, wherein each one shaft portion SH supports but one rotor R. However, even though not shown in the Figs., an RCE 100 may operate with more than two shaft portions SHs, wherein each one shaft portion supports more than one rotor R, and each one shaft portion may even support a same or a different number of rotors R. If desired, the rotors R supported by different shaft portions SH may have a same or a different volume.

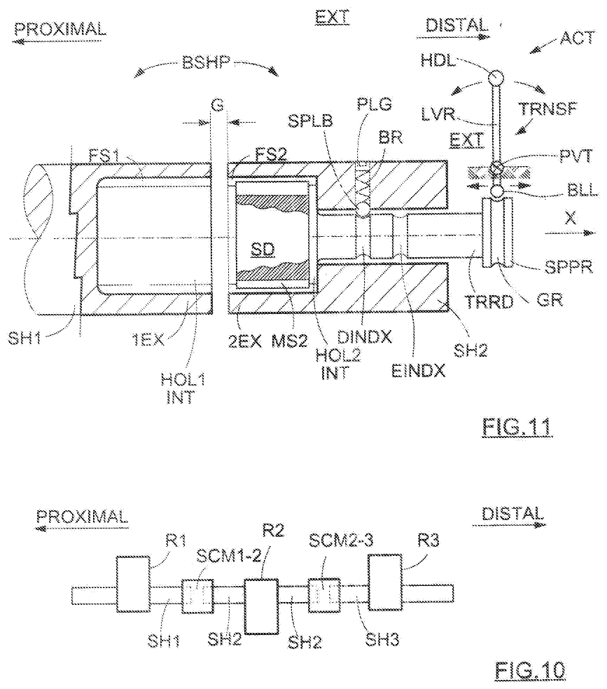

FIG. 10 illustrates a schematic depiction of an exemplary embodiment of an RCE 100 having three shaft portions, indicated respectively as SH1, SH2, and SH3, wherein each one shaft portion supports one rotor indicated as R1, R2, and R3. Two shaft coupling mechanism SCM, namely a first and a second, respectively, shaft coupling mechanism SCM1-2 and SCM2-3, may couple respectively, between the first shaft portion SH1 and the second shaft portion SH2, and between the second shaft portion SH2 and the third shaft portion SH3. The first shaft coupling mechanism SCM1-2 couples between the first and the second shaft portions, respectively SH1 and SH2. Likewise, the second shaft coupling mechanism SCM2-3 couples between the second and the third shaft portions, respectively SH2 and SH3. It is noted that each one out of the three shaft portions SH1, SH2, and SH3 may support more than one rotor R. The configuration illustrated in FIG. 10 permits to disengage one or two shaft portions SH, respectively either the shaft portion SH3, or both shaft portions SH2 and SH3. It is thereby possible to deactivate the rotors Rs supported by those shafts portions, namely either the rotor R3, or both rotors R2 and R3. For example, a disengagement operation of the second shaft coupling mechanism SCM2-3 may disengage the third shaft portion SH3 from the first and the second shaft portion, respectively SH1 and SH2. Thereby, the rotor R3 will be deactivated, but not so for the first and the second rotors R, respectively R1 and R2. In addition, a disengagement operation of the first proximal shaft coupling mechanism SCM1-2 will disengage the second and the third shaft portions, respectively SH2 and SH3, from the first shaft portion SH1. Thereby, the second and the third rotor, respectively R2 and R3, will be deactivated, but not so for the first rotors R1.

The RCE 100 may operate a plurality of n shaft portions SH, wherein each one shaft portion SH supports a plurality of m rotors R. In general, an RCE 100 may have n shaft portions SH[SH1, SH2, SH3, . . . SHn], wherein each one shaft portion SH supports m rotors R[R1, R2, R3 . . . Rm]. Evidently, n−1 shaft coupling mechanisms SCM coupling the n shaft portions SH are sufficient to disengage (n−1) shaft portions SH2 to SHn from the first shaft portion SH1, and these (n−1) disengaged shaft portions will then deactivate a maximum of (n−1) times m rotors Rs, or m*(n−1) rotors Rs that the shaft portions SH2 to SHn support.

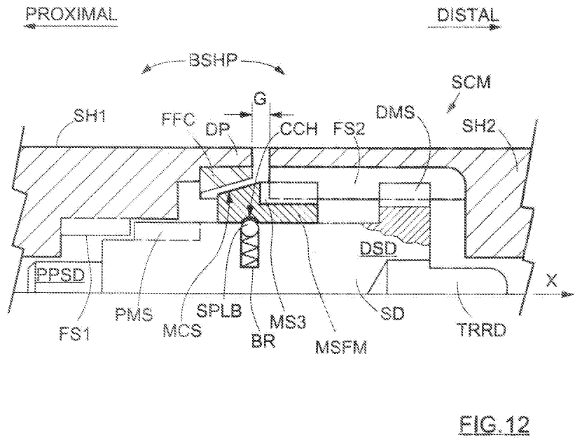

FIG. 11 is a schematic illustration of an exemplary embodiment which is disposed in the disengaged state, wherein the second shaft portion SH2 is disengaged from the first shaft portion SH1 by the gap G. Therefore, when the RCE 100 is running, thus in rotative operation, the rotor(s) R(s), not shown in FIG. 11, which are supported by the second shaft portion SH2 are deactivated, which means that neither the second shaft portion SH2, nor the rotor R2 supported thereby are rotating.

The distal and the proximal first and second facing extremities 1EX and 2EX of respectively, the first and the second shaft portions SH1 and SH2, may each one have a facing hollowed out portion HOL, indicated as HOL and HOL2. If desired, the entire length of the first and the second shaft portions SH1 and SH2 may have a hollowed out tubular interior INT, however at some cost to rigidity.

In FIG. 11, the shaft coupling mechanism SCM is configured as a sliding slide dog SD which is disposed in the second hollow-out HOL2. A translation rod TRRD, or motion transfer rod TRRD which is fixedly attached to slide dog SD may extend to the exterior EXT distal to the second shaft portion SH2.

To engage both shaft portions BSHP, thus the first and the second shaft portions respectively SH1 and SH2, for rotation together in common, the slide dog SD having male splines MS is translated proximally along the female splines FS2 of the second shaft portion SH2 over and across the gap G. The slide dog SD which bridges the gap G is driven further proximally to engage the female splines FS1 of the first shaft portion SH1. Thereby, both shaft portions BSHP now form one united rotating shaft which rotates the rotor(s) R(s) supported by the first shaft portion SH1 and the second shaft portion SH2.

The shaft coupling mechanism SCM, here the slide dog SD, may be translated via a motion transfer member(s) TRNSF operated by an actuator ACT.

In FIG. 11, the motion transfer rod TRRD is shown to be fixedly coupled to the slide dog SD while the distal portion thereof, on the distal exterior EXT of the second shaft portion SH2, is supported by a support ring SPPR having a circumferential groove GR. The support ring SPPR may be formed as a unitary ring fixedly attached to the motion transfer rod TRRD or may be journalled thereto for rotation by a suitable bearing, such as by a rotary bearing for example, but not shown in the Figs. A pivotable lever LVR, operated for example by a user U by aid of a handle HDL, may be pivoted about a stationary pivot point PVT. Opposite to the handle HDL, the lever LVR has a ball BLL that engages the groove GR of the support ring SPPR. To translate the slide dog SD, it suffices to pivot the lever LVR about the stationary pivot PVT. In response thereto, the support ring SPPR will translate the motion transfer rod TRRD and also the slide dog SD, to penetrate into engagement with and into the proximal first shaft portion SH1 or either, to retract the slide dog SD distally back into the second hollowed out portion HOL2. It is noted that the second shaft portion SH2 may support a spring loaded ball SPLB that is retained in a bore BR closed by a plug PLG. When the slide dog SD is disposed in the disengaged state, as shown in FIG. 11, the spring loaded ball SPLB indexes the motion transfer rod TRRD into a proximal disengaged index position circumferential groove DINDX which is cut in the motion transfer rod TRRD. Upon manipulation of the handle HDL of the lever LVR, the motion transfer rod TRRD may drive the slide dog SD in distal direction into the second hollow out HOL2 for the spring loaded ball SPLB to become engaged in the distal engaged index position circumferential groove EINDX of the motion transfer rod TRRD. Pushing the handle HDL of the lever LVR into the proximal direction will retrieve the slide dog SD distally for the motion transfer rod TRRD to be disposed in the disengaged index position DINDX as shown in FIG. 11.

FIG. 11 illustrates an exemplary embodiment for engaging the sleeve dog DS into the first shaft SH1 when the RCE 100 is either at standstill of running at idle RPM (Revolutions Per Minute). When the RCE 100 is at standstill, operation of a starter motor pertaining to the RCE 100 but not shown in the Figs., may rotate and engage the first and the second shaft portions SH1 and SH2 into appropriate relative angular disposition, to match the required mutual angular indexed correspondence of the rotors R.

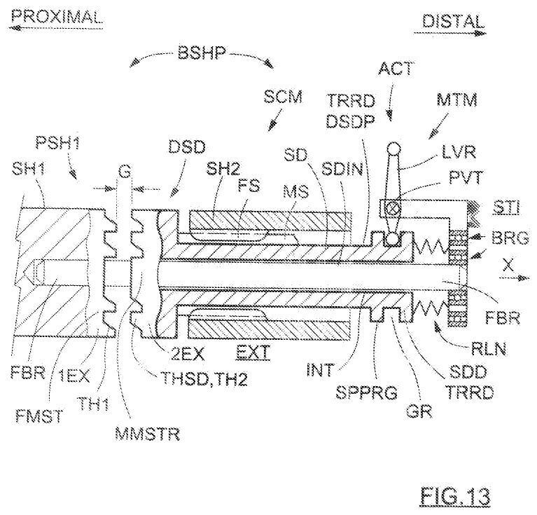

FIG. 12 schematically illustrates an exemplary embodiment for the rotational speed synchronization and the matching of angular indexing correspondence which allow the shaft coupling mechanism SCM to engage the first and the second shaft portions respectively SH1 and SH2, when the RCE 100 runs at idle speed and in working condition exceeding idle speed.

FIG. 12 illustrates a first shaft portion SH1, a second shaft portion SH2, a shaft coupling mechanism SCM including a slide dog SD, and a male slidable friction member MSFM. The slide dog SD, which in FIG. 12 is not yet engaged with the first shaft portion SH1, is shown to have distal male splines DMS in engagement with the female splines FS2 of the second shaft portion SH2. Consequently, the female splines FS2 guide the distal male splines DMS in longitudinal translation and rotate the slide dog SD when the second shaft portion SH2 rotates. The male slidable friction member MSFM has a male conical surface MCS and a male spline MS3 which is guided for translation and rotation by the female splines FS2 of the second shaft portion SH2. Furthermore, the slide dog SD has proximal male splines PMS which are disposed opposite the female splines FS1 of the first shaft portion SH1, for engagement therewith.

The distal portion DP of the first shaft portion SH1 supports a female friction cone FFC for engagement with the thereto opposite male conical surface MCS. In the slide dog SD, a spring loaded ball SPLB is retained in a bore BR, here a radial blind bore, for the spring loaded ball SPLB to engage a circumferential channel CCH cut in the male slidable friction member MSFM. Thereby, the spring loaded ball SPLB retains the male slidable friction member MSFM in desired position relative to the slide dog SD. It is noted that indexing mechanisms other than a spring loaded ball SPLB may be used to hold the male slidable friction member MSFM in desired position. However, proximal translation of the slide dog SD brings the male slidable friction member MSFM in contact with the female friction cone FFC. Further proximal translation of the slide dog SD urges the distal mail splines DMS against the male slidable friction member MSFM may push the spring loaded ball SPLB out of the circumferential channel CCH and permit some additional distal translation of the slide dog SD relative to the first shaft portion SH1. Evidently, mechanisms different from a spring loaded ball SPLB retained in a bore BR may be used to keep the male slidable friction member MSFM in desired position relative to the slide dog SD.

As described hereinbelow with reference to FIG. 12, to engage the second shaft portion SH2 with the first shaft portion SH1, the motion transfer rod TRRD is translated proximally. Thereby, the distal male splines DMS of the slide dog SD slide proximally along the female splines FS2 and push the male friction member MSFM towards the female friction cone FFC to achieve contact with the male conical surface MCS. The frictional contact between the male conical surface MCS and the rotating female friction cone FFC will bring the second shaft portion SH2 up to, or almost up to the rotational speed of the first shaft portion SH1, whereby rotational speed synchronization will be achieved while shocks will be mitigated. Simultaneously upon frictional contact of the male conical surface MCS with the female friction cone FFC, due to the proximal translation of the slide dog SD, the female friction cone FFC pushes the male friction member MSFM distally and thereby drives the spring loaded ball SPLB out of the circumferential channel CCH. This will permit distal translation of the male slidable friction member MSFM relative to the slide dog SD, over the spring loaded ball SPLB. Further proximal translation of the slide dog SD towards the first shaft portion SH1 translates the proximal male splines PMS along the female splines FS1 of the first shaft portion SH1 for engagement in angular phase synchronization with the slide dog SD and thus with the second shaft portion SH2. Although not shown in FIG. 12, it is assumed that the proximal male splines PMS have a projecting male master spline MMSTR and that the female spline FS1 has a matching recessed female master spline FMST.

To disengage the second shaft portion SH2 from engaged rotation with the first shaft portion SH1, the motion transfer rod TRRD, which is fixedly coupled to the slide dog SD, is translated distally. Thereby, the first proximal male splines PMS are retrieved out of the female splines FS1 and contact is broken between the female friction cone FFC and the male conical surface MCS. Further distal translation of the slide dog SD will cause the distal male splines DMS to return the male slidable friction member MSFM in position over the spring loaded ball SPLB.

The motion transfer rod TRRD may be translated, for example, by action thereon of a lever LVR. Such a lever LVR is but an example of a principle of embodiment of an actuator ACT since various other motion delivery actuators ACT may be used to translate the motion transfer rod TRRD via a motion transfer mechanism MTM, shown in FIGS. 9 and 13. Actuators ACT may include one, more, or a combination of mechanical, hydraulic, pneumatic and electric devices.

It is noted that FIG. 12 does not show design details. For example, the motion transfer rod TRRD may be journalled to the second shaft portion SH2, to the first shaft portion SH1, and likewise, the slide dog SD proximal portion PPSD may be journalled to the first shaft portion SH1.

The exemplary embodiment shown in FIG. 12 features a male conical surface MCS and a female friction cone FFC for speed of rotation synchronization as well as proximal male splines PMS and female splines FS1 for torque transmission and for angular indexed coupling. Rotation speed synchronization and indexed coupling operate in sequence to soften and damp the shocks resulting from the engagement and coupling of both shaft portions BSHP when the RCE 100 is running at, and even exceeds, idle rotation speed. This means that it is possible to engage both shaft portions BSPH with the RCE 100 at standstill, say by use of a starter, which is not shown in the Figs., or when running at idle rotation speed and in excess thereof. Disengagement of both shaft portions BSHP is possible with the RCE 100 at standstill, and at idle rotation speed.

FIG. 13 is a schematic illustration of an exemplary frontal coupling embodiment configured for engaging and disengaging the first shaft portion SH1 and the second shaft portion SH2. The distal portion PSH1 of the first shaft portion SH1 and the distal-side portion DSD of the tubular slide dog SD have mutually facing teeth, respectively TH1 and THSD. The set of teeth TH1 of the first shaft portion SH1 may have a male, thus projecting master tooth MMSTR, and the set of teeth THSD of the slide dog SD may have a matching, thus recessed female master spline FMST. The two sets of teeth TH1 and THSD are operative for angular indexing and for torque transfer.

The slide dog SD has male splines MS which engage female splines FS of the second shaft portion SH2. Hence, when the teeth TH1 and the teeth THSD of the slide dog SD are engaged, torque is transferred from the first shaft portion SH1 via the slide dog SD to the second shaft portion SH2 to achieve rotation speed synchronization and torque transfer.

The distal portion SDD of the slide dog SD is operative as a motion transfer rod TRRD which is coupled to a lever LVR via a support ring SPPRG having a circumferential groove GR. Pivotal displacement of the lever LVR about the stationary pivot PVT which is affixed to a stationary item STI of the RCE 100, may thus translate the slide dog SD into proximal or distal direction. For engagement of both shaft portions BSHP, the lever LVR may be pivotally operated to drive the teeth THSD of the slide dog SD proximally into the teeth TH1 of the first shaft portion SH1. To prevent an accidental disengagement of the sets of teeth TH1 and THSD, pressure exerting resilient element(s) RLN, such as pressure springs for example, may be provided, for the teeth THSD to apply pressure force onto the teeth TH1. The resilient element(s) RLN apply force on the distal portion SDD of the slide dog SD and are supported by a stationary portion or stationary item STI of the RCE 100, and if desired, may be journalled by at least one bearing BRG. However, to prevent the application of axial forces onto the first shaft portion SH1, there is provided a force balancing rod FBR which is fixedly coupled proximally to the first shaft portion SH1.

FIG. 13 illustrates in detail the distal first shaft extremity 1EX of the first shaft portion SH1 and the proximal second shaft extremity 2EX of the second shaft SH2.

To facilitate engagement of the first rotating shaft portion SH1 with the at standstill second shaft portion SH2 of the of the embodiments described hereinabove, the teeth of the splines may be chamfered. As indicated in FIG. 13, the first rotating shaft portion SH1 has teeth TH1 and the second shaft portion SH2 has teeth TH2. For example, the first shaft portion SH1 may rotate clockwise, as indicated by the arrow C, for the chamfer CHMF of the teeth TH1 to smoothly engage the set of teeth TH2.

At a proximal end thereof, the force balancing rod FBR is fixedly attached to the first shaft portion SH1, and at the distal end thereof, the force balancing rod FBR is fixedly attached to the stationary item STI of the RCE 100 to which the pivot PVT of the lever LVR is affixed. From the distal end side at the stationary item STI, the force balancing rod FBR extends to the first shaft portion SH1 through an interior INT of the tubular slide dog SD. If desired, the force balancing rod FBR may be supported by a ball bearing BRG at the distal end thereof.

The various embodiments described hereinabove may be implemented by conventional engine-building means, methods and materials, well known to those skilled in the art and do not require further details.

The operation of an RCE equipped with an embodiment of a reversible shaft disconnection or disengagement apparatus, such as described hereinabove, may be automatic or manual. The deactivation/reactivation of a rotor include but an ON/OFF command and needs not to be described.

There has thus been described a Rotary Combustion Engine (RCE) operating a plurality of rotors and including an apparatus suitable for the deactivation of at least one rotor out of the plurality of rotors. The RCE may comprise at least a first shaft portion and a second shaft portion, thus at least two lengthwise adjacent shaft portions which are disposed in straight coextensive longitudinal axial alignment to each other. Each one shaft portion is configured to support at least one rotor. The at least the first shaft portion and the second shaft portion are separated apart by a gap which is sufficient to prevent the transmission of rotation from one shaft portion to the other thereto adjacent shaft portion. A shaft coupling mechanism is operable to couple together the first shaft portion in engagement with the second shaft portion to operate rotation together of both shaft portions as if being a unitary solid one-piece shaft. Furthermore, the shaft coupling mechanism is operable to disengage the first shaft portion from the second shaft portion, thus to allow the gap to prevent rotation together of both the first shaft portion and the second shaft portion. Thereby, disengagement of the at least the first shaft portion and the second shaft portion causes one of both shaft portions to stop to rotate by not being driven anymore. In consequence, the disengaged and now stopped from rotation shaft portion thus deactivates the rotation of the at least one rotor which is supported thereby.

The engagement and the disengagement of the at least the first shaft portion and the second shaft portion by the shaft coupling mechanism may be controlled by either an automatic and independent engine control unit operating on the RCE or by a user who controls the operation of the RCE. Remote control is regarded as being equivalent to control by a user. An actuator or actuation mechanism may command the shaft coupling mechanism to engage together and disengage from each other of the at least the first shaft portion and the second shaft portion The force and the motion to operate the shaft coupling mechanism may be provided either physically by the user or by the actuator.

Each one of the at least the first shaft portion and the second shaft portion may have an exterior and either a local hollow out or a completely end to end hollow interior. There is thus formed a tube enhancing lubrication, as divulged by the Applicant in Israel Patent Application No. 241420 of Sep. 9, 2015. Actually, when in operation, lubricant flows through the hollow shaft or shaft portions and the RCE is filled with mist of lubricant. The shaft coupling mechanism is configured for bidirectional longitudinal translation in the hollow tubular interior or partial hollow out of the shaft portions.

The shaft coupling mechanism may be disposed for operation in one of the hollow interior or on an exterior of the at least the first shaft portion and the second shaft portion. For an RCE operating more than two shaft portions, there may be at least one shaft coupling mechanism operative in the interior of a shaft portion and at least one shaft coupling mechanism operative on the exterior of a shaft portion.

The shaft coupling mechanism may be selected as a slide dog which may be configured as a kind of bushing having male splines on an exterior surface thereof to accommodate translation in the interior of a shaft portion, or have female splines to accommodate translation on the exterior of a shaft portion, or be designed to have both male and female splines.

The first shaft portion and the second shaft portion may have a hollowed out interior which may be disposed at least along a portion of the first shaft portion and the second shaft portion, or may have a tubular hollow interior which is disposed along the entire length thereof. The shaft coupling mechanism may travel in longitudinal bidirectional translation along the portion or the entirety of the hollowed out interior.

The shaft coupling mechanism may also travel in longitudinal bidirectional translation along an exterior surface of the at least first shaft portion and second shaft portion on both the interior thereof and the exterior surfaces.

The actuator which operates the shaft coupling mechanism may be selected alone or in combination as at least one of a device which is mechanic, pneumatic, hydraulic, or electric.

The shaft coupling mechanism may engage the first shaft portion and the second shaft portion by crossing or bridging over the gap, for rotation in common when the RCE is at standstill, or is running at idle speed, or is running in operative condition. The shaft coupling mechanism may disengage the first shaft portion from the second shaft portion when the RCE is at standstill or is idling. Furthermore, the shaft coupling mechanism may engage the first shaft portion and the second shaft portion in synchronous rotation and at a predetermined indexing angle.

The activation and the deactivation of the at least one rotor may be commanded automatically by the engine control unit or be operated directly by the user. Activation and deactivation refer to respectively, an engaged state and a disengaged state of at least a first shaft portion and a second shaft portion. In the engaged state more than one rotor is operative, and in the disengaged state, at least one rotor is deactivated. Activation is to be understood as engaging, thus coupling together at least a first shaft portion and a second shaft portion for rotation in balanced, journalled, and well lubricated operation, in rotational speed synchronization and angular phase adjustment.

There may thus be implemented an RCE 100 having a plurality of n shaft portions wherein each one shaft portion out of the plurality of n shaft portions supports m rotors, and wherein the n shaft portions are coupled to n−1 shaft coupling mechanisms to deactivate a maximum of n−1 times m rotors.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb. The words “comprising” and “including” do not exclude other elements or steps, and the indefinite claims does not indicate that a combination of these measures cannot be used to advantage article “a” or “an” does not exclude a plurality.

Furthermore, while the present application or technology has been illustrated and described in detail in the drawings and foregoing description, such illustration and description are to be considered illustrative or exemplary and non-restrictive; the technology is thus not limited to the disclosed embodiments. Variations to the disclosed embodiments can be understood and effected by those skilled in the art and practicing the claimed technology, from a study of the drawings, the technology, and the appended Although the present embodiments have been described to a certain degree of particularity, it should be understood that various alterations and modifications could be made without departing from the scope of the invention as hereinafter claimed.

### INDUSTRIAL APPLICABILITY

The embodiments described hereinabove may be implemented by use of materials and manufacturing techniques well known to those skilled in the art of RCE construction. Therefore, such embodiments are applicable to the RCE production industry.

### REFERENCE SIGNS LIST

# Item
ACT actuator
BR bore
BLL ball
BRG bearing
BSHP both shaft portions
C clockwise
CCH circumferential channel
CHMF chamber
DINDX disengaged index position groove
DIS disengaged
DMS distal male splines
DSD distal portion SD
DP distal portion
ECU engine control unit
EINDX engaged index position groove
ENG engaged SHs
EXT exterior
FBR force balancing rod
FFC female friction cone
FMST female master spline
FR1 front face of SH1
FR2 front face of PST
FS female spline
FS1 female spline of SH1
FS2 female spline of SH2
G gap
GR groove
HDL handle
HOL hollowed out portion
HOL1 hollowed out portion of SH1
HOL2 hollowed out portion of SH2
INT interior
LNGB longitudinal bore
LVR lever
MCS male conical surface
MMSTR male master spline
MS male spline
MS1 male spline of SH1
MS2 male spline of SH2
MSFM male slidable friction member
MTM motion transfer mechanism
PLG plug
PMS proximal male spline
PPSD proximal portion of SD
PSH1 proximal portion
PST piston
PVT pivot
R(s) rotor(s)
R1 rotor 1
R2 rotor 2
R3 rotor 3
RCE Rotating Combustion Engine, 100
RLN resilient element(s)
RPM revolutions per minute
S spline
SCM shaft coupling mechanism
SCM1-2 first SCM
SCM2-3 second SCM
SD slide dog
SDINT slide dog interior
SDD distal portion of SD
SH shafts portions
SH1 first shaft portion
SH2 second shaft portion
SH3 third shaft portion
SHFT shaft
SPLB spring loaded ball
SPPRG support ring
STI stationary item
TH1 teeth of SH1
TH2 teeth engaging TH1, teeth of SH2
THSD teeth of SD
TRNSF motion transfer member
TRRD motion transfer rod
TRSH translation shaft
U user
X axis
1EX first shaft extremity
2EX second shaft extremity
100 RCE

I claim:

1. A Rotary Combustion Engine (RCE) suitable for deactivation of at least one rotor of a plurality of rotors, the RCE comprising:
a shaft having at least a first shaft portion and a second shaft portion which are disposed in coextensive longitudinal coaxial alignment, and wherein each shaft portion supports at least one rotor;
a gap which separates the first shaft portion and the second shaft portion; and
a shaft coupling mechanism configured to:
engage the first shaft portion and the second shaft portion for rotation together, and
disengage one of the first shaft portion and the second shaft portion to deactivate rotation of the at least one rotor.

2. The RCE of claim 1, wherein engagement and disengagement of the shaft coupling mechanism is controlled by one of an engine control unit and a user.

3. The RCE of claim 2, wherein an actuator is configured to engage and to disengage the first shaft portion and the second shaft portion.

4. The RCE of claim 3, wherein:
the first shaft portion and the second shaft portion have a hollow interior, and
the shaft coupling mechanism is configured for bidirectional longitudinal translation in the hollow interior.

5. The RCE of claim 4, wherein the shaft coupling mechanism is disposed for operation in one of the hollow interior and an exterior of the first shaft portion and the second shaft portion.

6. The RCE of claim 5, wherein the shaft coupling mechanism is configured as a slide dog.

7. The RCE of claim 6, wherein:
the actuator is coupled to and operates the shaft coupling mechanism, and
the actuator is selected alone or in combination as at least one of a device which is mechanic, pneumatic, hydraulic, and electric.

8. The RCE of claim 7, wherein the shaft coupling mechanism is configured to engage the first shaft portion and the second shaft portion when the RCE is either standstill or running at idle speed.

9. The RCE of claim 8, wherein the shaft coupling mechanism is configured to disengage the first shaft portion and the second shaft portion when the RCE is either standstill or running.

10. A Rotary Combustion Engine (RCE) suitable for deactivation of at least one rotor of a plurality of rotors, the RCE comprising:
a shaft having at least a first shaft portion and a second shaft portion which are disposed in mutual coextensive longitudinal axial alignment, and wherein each shaft portion supports at least one rotor;
a gap which separates the first shaft portion and the second shaft portion;
a shaft coupling mechanism engaged with the second shaft portion and configured for engagement with the first shaft portion and the second shaft portion; and
an actuator configured to:
translate the shaft coupling mechanism across the gap to engage the first shaft portion and the second shaft portion for rotation together, and
disengage one of the first shaft portion and the second shaft portion to deactivate the at least one rotor.

11. A method for reversibly deactivating at least one rotor of a plurality of rotors of a Rotary Combustion Engine (RCE), the method comprising:
providing the RCE with a shaft having at least a first shaft portion and a second shaft portion that are disposed in mutual coextensive longitudinal axial alignment and wherein each shaft portion supports at least one rotor;
separating the first shaft portion and the second shaft portion by a gap; and
providing a shaft coupling mechanism configured for:
coupling across the gap of the first shaft portion and the second shaft portion into simultaneous rotation, and
deactivating at least one rotor of the plurality of rotors by uncoupling the first shaft portion and the second shaft portion.

12. The method of claim 11, wherein an actuator is operative for bidirectional axial translation of the shaft coupling mechanism along the first shaft portion and the second shaft portion.

13. The method of claim 11, wherein the shaft coupling mechanism engages the first shaft portion and the second shaft portion in synchronous rotation and at a predetermined mutual relative angle.

14. The method of claim 11, wherein activating and deactivating the at least one rotor is commanded by one of an engine control unit and a user.

15. The method of claim 11, wherein:
the first shaft portion and the second shaft portion have one of an exterior, and an exterior and a hollowed out interior, and
engagement and disengagement of the first shaft portion and the second shaft portion is achieved by translation of the shaft coupling mechanism across the gap along one of the exterior and the interior.

16. The method of claim 11, wherein the RCE has:
an engaged state wherein the rotors supported by the first shaft portion and the second shaft portion are operative, and
a disengaged state wherein at least one rotor is deactivated.

17. The method of claim 11, wherein the shaft coupling mechanism engages the first shaft portion and the second shaft portion in one of an exterior engagement, an interior engagement, and a frontal engagement.

18. The method of claim 11, wherein the shaft coupling mechanism is operative for controlled bidirectional translation in a hollowed out interior for engagement and disengagement of the first shaft portion and the second shaft portion.

19. The method of claim 11, wherein force and motion to operate the shaft coupling mechanism is provided by a user.

20. The method of claim 11, further comprising:
providing a plurality of n shaft portions, wherein each shaft portion of the plurality of n shaft portions supports m rotors; and
providing n−1 shaft coupling mechanisms coupling the n shaft portions to deactivate a maximum of n−1 times m rotors.
